(19) United States
(12) Patent Application Publication
(10) Pub. No.: US 2009/0269724 A1
(43) Pub. Date: Oct. 29, 2009

(54) Flight Simulator with Dual Joystick

(76) Inventor: James Elmer Thomas, Dry Ridge, KY (US)

Correspondence Address: JAMES E THOMAS, 1760 DRY RIDGE- MT. ZION RD, DRY RIDGE, KY, 41035, US

(21) Appl. No.: 12/368,289

(22) Filed: Feb. 9, 2009

Related U.S. Application Data
(60) Provisional application No. 61/032,213, filed on Feb. 28, 2008.

(51) Int. Cl. G09B 9/08

(52) U.S. Cl. 434/45

(57) ABSTRACT

A flight simulator, being a scaled model of an actual aircraft, equipped with a dual action joystick, to allow an operator to control a computer simulator program and movement of the simulator with one joystick. The roll movements of the simulator being accomplished by an actuator attached to the cockpit structure through an articulating member and another actuator connected to the pivotal pitch boom to provide ascent and descent movements. Both actions are controlled by movement of the joystick by the occupant who watches the action on the computer monitor and synchronously feels the movement of the simulator.

### CROSS-REFERENCE TO RELATED APPLICATIONS

This application claims the benefit of provisional patent application Ser. No. 61/032,213 filed 2008 Feb. 28 by the present inventor.

### FEDERALLY SPONSORED RESEARCH

Not applicable

### SEQUENCE LISTING OR PROGRAM

Not Applicable

### BACKGROUND

1. Field

This application relates generally to the field of flight simulators for training and amusement purposes, and more particularly to simulators which mimic perceived movements of aircraft in flight.

2. Prior Art

In the early days of aviation, flight instructors became aware that most of the training of student pilots could be done more economically and with greater safety using a mock-up on the ground than with an actual flying aircraft. From this came the first large box-like simulators equipped inside with the instrumentation including the guidance equipment of an actual aircraft. A movie type projector was used to produce the visual aspects of take-offs and landing as well as other maneuvers which the students were expected to learn. Such simulators were used for several years by the military as well as commercial training facilities with little or no thought being given to their use by the general public probably due to the extreme costs.

With the computer age came the flight simulator software produced by several software companies, at a very reasonable cost, that teaches the art of flying to an amazing degree as the user sits in a chair in front a computer monitor using the keyboard to direct the flight. Several upgrades now allow the operator to enjoy the use of a joystick, to enjoy the scenery at the airport chosen and even choose the type of plane used for the flight.

In recent years inventors have attempted to further improve the simulator by using a yoke, and foot petals to more closely resemble those used in larger aircraft as does U.S. Pat. No. 4,713,007 to Alban (1987) and U.S. Pat. No. 4,659,313 to Kuster (1987). Others have secured patents introducing a means of having the pilot compartment move as to mimic the movements of the actual plane in flight as U.S. Pat. No. 6,902,402 B2 to McClintic (2005) and U.S. Pat. No. 5,791,903 to Feuer, et al. (1998).

The present invention provides a scaled model of an actual aircraft used as the simulator, equipped with an improved joystick which enables both the flight simulator program and the simulator itself to be controlled by the same joystick. This allows the simulator to make exactly the same movements as those of the simulator program displayed on the monitor seen by the operator.

The simplicity of construction with materials readily available at local lumber yards, building supply stores and the internet enables this simulator to be manufactured, or built by a average handyman, at a cost comparable to that of today's back yard play-ground equipment.

This simplicity of construction and other advantages will be evident from the following descriptions, the accompanying drawings and the appended claims

### BRIEF DESCRIPTION OF THE DRAWINGS

FIG. 1 is a perspective view of the entire simulator with its method of support, the location of the joystick, the laptop computer and the location of the simulated jet engine exhaust and afterburner.

FIG. 2 is a view of the joystick with the retrofitted extentions and switches which control the hydraulic unit which in turn controls the movements of the simulator.

FIG. 3 is a cutaway of the cockpit basket which actually supports the weight of the simulator, and also shows the pitch and roll motion components.

FIG. 4 is a cutaway of the cockpit showing the location of the hydraulic unit, an exploded view of the joystick, the laptop computer with monitor, and also a view of an exterior monitor.

FIG. 5 shows a cutaway of the simulated jet engine and afterburner.

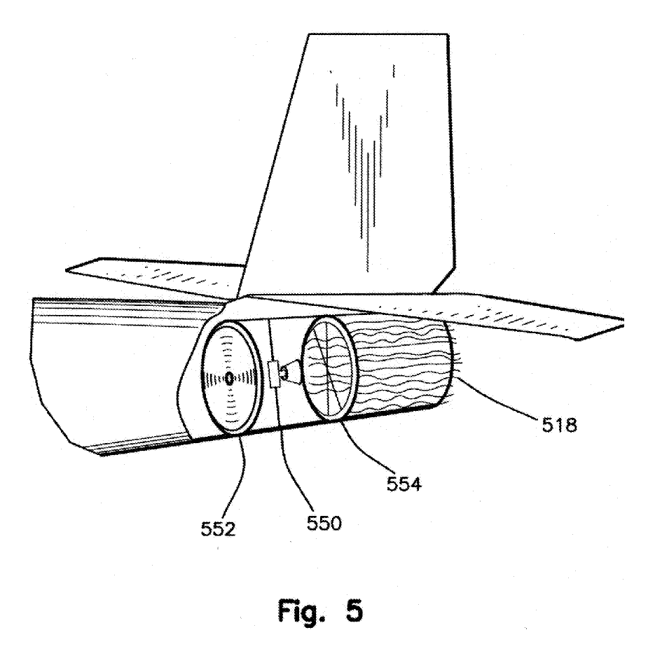

FIG. 6 Prior art. U.S. Pat. No. 5,453,011 FIG. 6A Prior art U.S. Pat. No. 6,634,885 B2

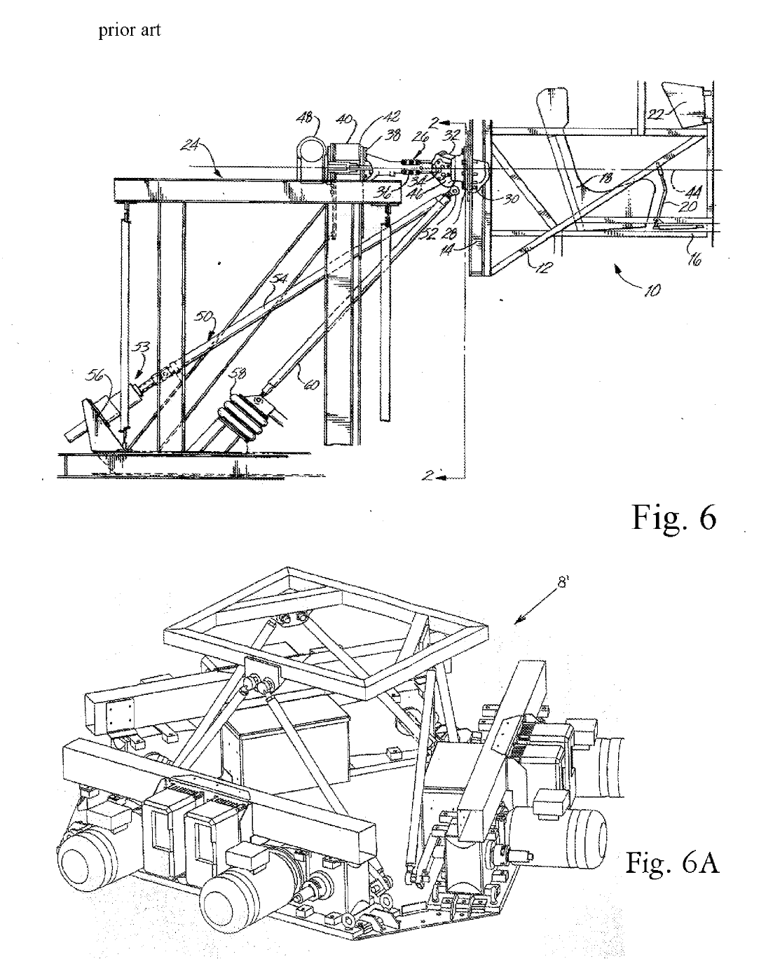

### SUMMARY OF THE INVENTION

The flight simulator of the present invention incorporates a scaled model of actual aircraft with a cockpit designed to accommodate an operator, equipped with a laptop computer with monitor located on the dash near the joystick. The input to the computer through the USB cable from the joystick and the output from the joystick to the hydraulic unit are accomplished by a single movement of the joystick. The laptop is removable when not used for this purpose.

The hydraulic unit is from a manufacturer of similar units used in dentist chairs and hospital beds, ⅓ HP reversible electric motors with a pump developing 600 lbs PSI, using double action cylinders with relief valves, also equipped with electric solenoids, normally closed, input is from the 115 volt circuit in the dual action joystick. The switches are double-pole, double-throw, by necessity, to activate the cylinders and the solenoids at the same time. The simulated jet engine incorporates a forward fan, not shown, used also for ventilation of the cockpit when the canopy is down, and a rear fan to activate the afterburner which is wired to respond when the joystick is in the climb mode.

The object of the present invention is to provide an inexpensive flight simulator for operators of all ages, that will allow the operator to control both the flight simulator program and the simulator itself by use of a dual action joystick.

### DETAILED EXPLANATION OF THE INVENTION

At the onset it should be understood that like reference numbers are intended to identify the same structural elements and that the first digit of all reference numbers indicate the drawing figure number.

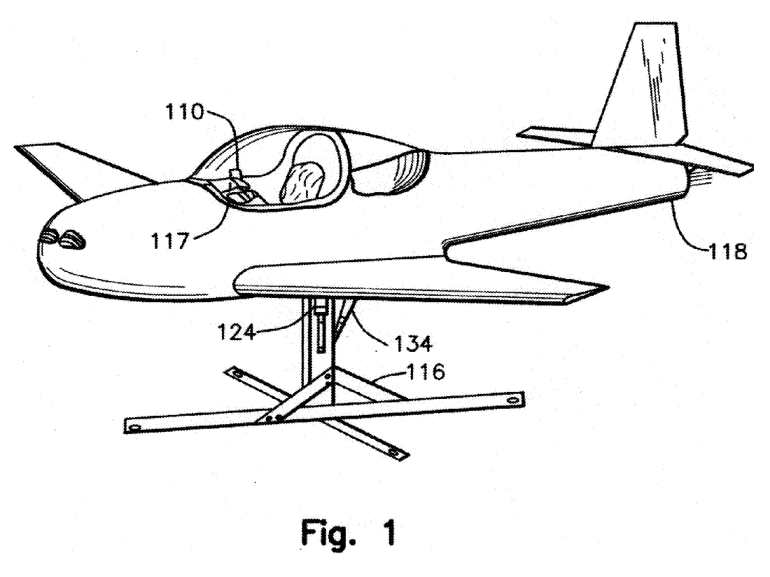

Referring now to the drawings in numerical order, in FIG. 1 the placement of the joystick is indicated by ref. 110, the location of the laptop computer 117. The hydraulic cylinder 124 is attached midway of the cockpit basket as also indicated in 324 and when activated by the joystick moves the basket up or down to cause the simulator to roll left or right, likewise the pitch axis is controlled by the other cylinder 134 as commanded by the joystick, the simulated jet engine is 118.

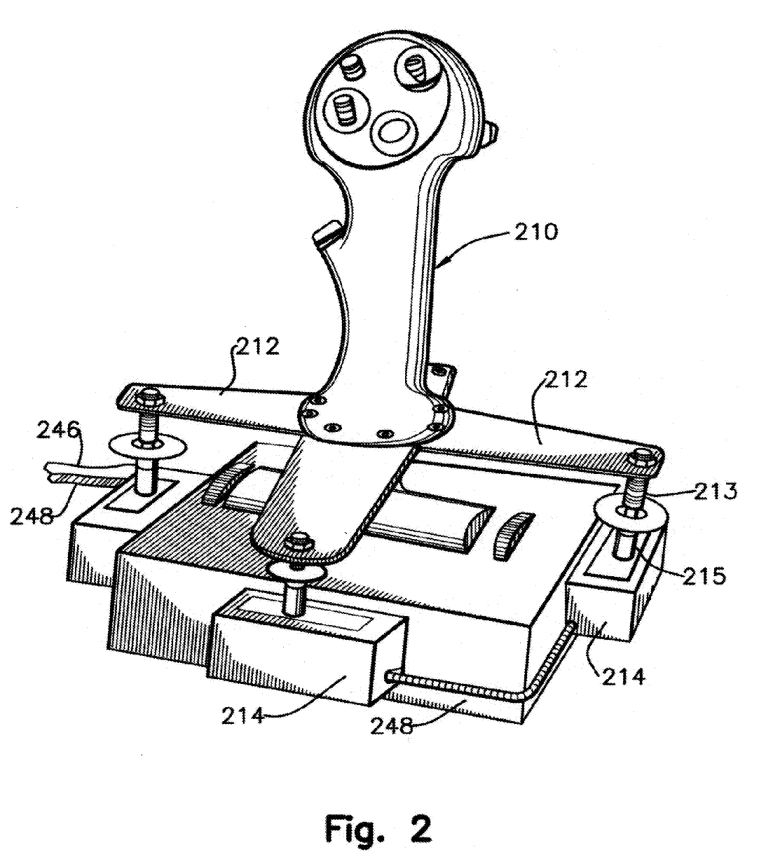

The joystick 210 in FIG. 2 is a CH Combatstick, which accepted the retrofitting well since the base is deep enough to allow the attachment of the switch holders 214 and switches 215 which with the actuator arms 212 make it a dual action unit. The adjustable contactors 213 are necessary to synchronize the impulse from the joystick to the hydraulic system via the ten wire cable 248, with that going from the joystick to the computer via the USB cable 246.

Any possible misalignment between the two circuits caused by difference in response speed can be corrected by the operator manually at 213 by use of thumb and fore-finger.

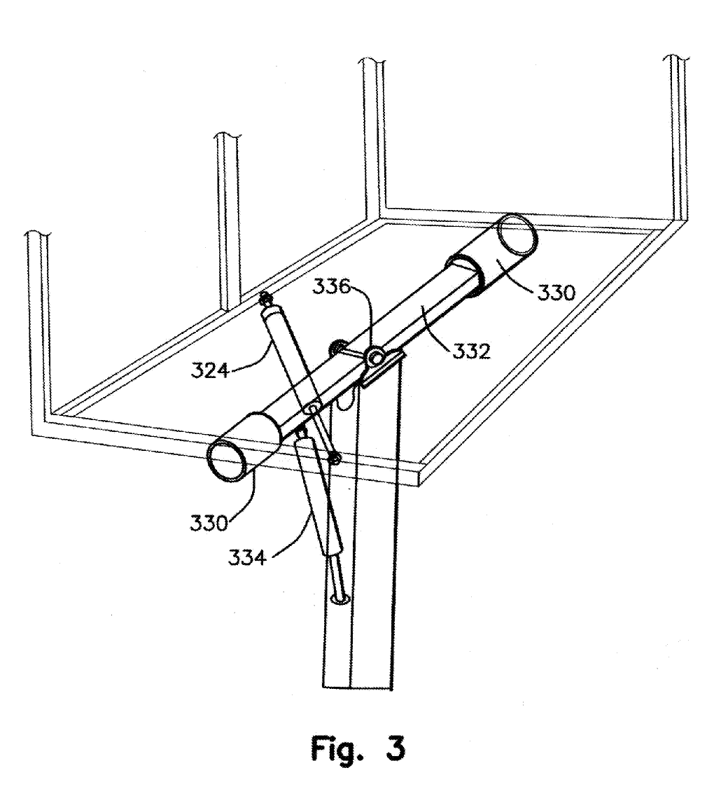

The cockpit basket in FIG. 3 shows the working parts of the simulator. The pitch boom 332 spanning the length of the frame is attached to the support post by metal pin through the middle into saddle bearings 336 located on each side. At each end of the pole a bushing type bearing is formed by a section of pipe 330 large enough to slide over the pitch boom 332 and allow enough space to allow the insertion of a pre-lubricated bearing material. This assembly is moved up or down by one of the cylinders 334 from the hydraulic unit. The aforementioned section of larger pipe forms the axis for the basket which is welded to the end sections 330 and is moved to either side by the other cylinder 324.

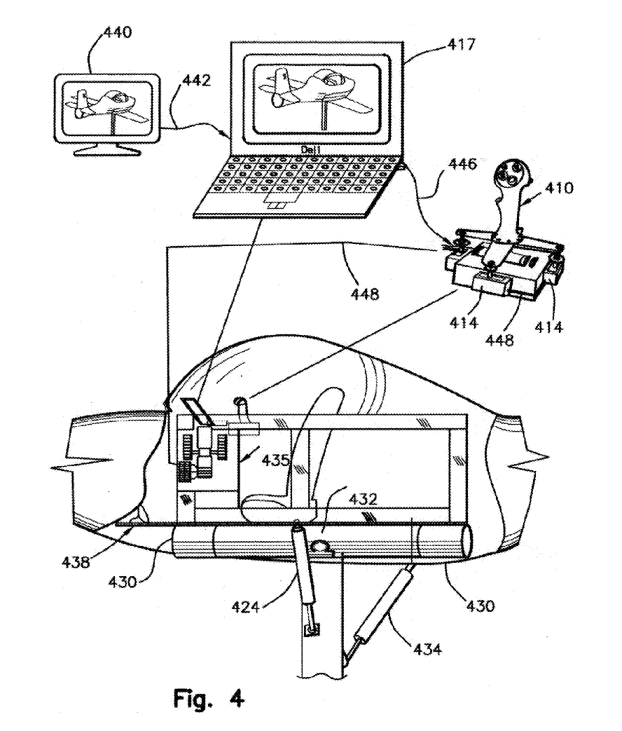

An exploded view in FIG. 4 shows the location of the joystick 410 and the laptop 417 inside the cockpit as well as the location of the hydraulic unit 435, the foot brace 438 and the fifteen pin cable 442 to the exterior projector 440. Such exterior projectors can be located as much as fifty feet away for monitoring by an instructor or students in a classroom setting.

The simulated jet engine consists of a forward fan, not shown, to provide ventilation for the cockpit when closed as well as some jet noise. The rear fan 552 provides more jet noise and cools the floodlight 550 while activating the silk strips 518 tied to the grid 554, all of which comprise the afterburner.

Numerous variations of the above described flight simulator will become apparent to one skilled in the art in view of the above descriptions. Such simulators are to be deemed within the scope of the present invention.

Drawing reference numbers

| | |
|---|---|
| 110-210-410 | joystick |
| 116 | base |
| 117--417 | laptop |
| 118-518 | afterburner |
| 124-324-424 | roll actuator |
| 134-334-434 | pitch actuator |
| 212 | actuator arms |
| 213 | adjustment screw |
| 214-414 | switch brackets |
| 215 | switches |
| 216-416 | USB cable |
| 248-448 | 10 pr cable |
| 330-430 | bearings |
| 332-432 | pitch boom |
| 336 | saddle bearing |
| 440 | remote projector |
| 442 | 15 pin cable |
| 435 | hydraulic unit |
| 438 | foot brace |
| 550 | floodlight |
| 552 | fan |
| 554 | grid |

What is claimed is:

1. A flight simulator, comprising;
a scaled model of an actual aircraft incorporating a horizontal support base and a vertical support post:
a pitch boom secured at mid point at the top of the said vertical support post by saddle bearings allowing movement of said pitch boom by a vertical actuator attached to said vertical support post, having a lubricated bushing type bearing formed at each end by a larger section of pipe.
a cockpit compartment being secured atop the said bearing assemblies allowing said compartment to be moved by the other actuator attached to the vertical support, thus producing the roll movements of the entire simulator.

2. The flight simulator of claim 1 wherein the cockpit compartment consists of a metal box-type structure the base being of angular metal and attached horizontally atop the bearing assemblies at each end of the pitch boom.

3. The flight simulator of claim 1 wherein the actuators are part of the hydraulic unit controlled by the joystick.

4. A flight simulator comprising;
a modified joystick having a USB connection to a laptop computer containing a flight simulator program, and also having a 110 volt circuit for operation of a hydraulic system so as to control both units by a single movement of said joystick.

5. The flight simulator of claim 5 wherein said joystick contains a means to adjust the movements of the contacts with the switches to insure a simultaneous impulse to the computer and the hydraulic unit.

6. The flight simulator of claim 5 further comprises a means to manually realign the said impulses should such misalignment occur during a long flight or several continuing maneuvers.

7. The flight simulator comprising
a simulated jet engine assembly located near the rear of said simulator with a simulated afterburner;

8. The flight simulator of claim 7 wherein the jet engine assembly comprising a length of galvanized pipe containing a fan, a floodlight, and a grid with a number of silk strands attached, simulate the afterburner, activated by the climb mode of the joystick.
